(19) United States
(12) Patent Application Publication
(10) Pub. No.: US 2006/0266834 A1
(43) Pub. Date: Nov. 30, 2006

(54) Coded optical media to enable functionality on secure drive system

(75) Inventor: Jathan D. Edwards, Afton, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/440,324

(22) Filed: May 23, 2006

Related U.S. Application Data
(60) Provisional application No. 60/684,325, filed on May 24, 2005.
(60) Provisional application No. 60/707,060, filed on Aug. 10, 2005.

(51) Int. Cl. G06K 7/10; G06K 19/00

(52) U.S. Cl. 235/454; 235/487

(57) ABSTRACT

The invention is directed to coded optical media that allows a proprietary media handling system to enable privileged access or particular drive features on an optical drive system. In particular, a coded optical medium comprises an otherwise standardized format optical medium that includes machine readable indicia that can be read by the proprietary media handling system regardless of the orientation of the optical medium in the proprietary media handling system. The proprietary media handling system allows access to data stored on medium or, alternatively, enables special features if the indicia identifies the medium as being compliant with drive system. In this manner, the coded optical media and media handling system prevent non-certified media use in the optical drive system or, alternatively, enable specialized features only with optical media having accepted coding.

This application claims the benefit of U.S. Provisional Application No. 60/684,325 filed May 24, 2005, and U.S. Provisional Application No. 60/707,060 filed Aug. 10, 2005, the entire contents of which are incorporated herein by reference.

### TECHNICAL FIELD

The invention relates to data storage systems and, more particularly, to coded optical media storage systems.

### BACKGROUND

Optical media provide high capacity removable storage of digital data with a long life. Optical media store data in accordance with industry standard formats such as compact disc-recordable/rewritable (CD-R/RW), digital versatile disk recordable/rewritable (DVD+/-R/RW), high definition-digital versatile disk-recordable/rewritable (HD-DVD-R/RW), and Blue-Ray disc-recordable/rewritable (BD-R/RE). These standard formats have resulted in competitive pricing and volume production of both optical media and drive elements. In addition, these standard drive formats enable interchangeability or compatibility of optical media made by a number of manufacturers across a number of drive platforms. For example, a CD-R disc can be read on almost any CD-ROM drive, CD-R or CD-R/RW recorder, MultiRead-compliant DVD-ROM drive or recorder, and most consumer electronics.

Optical media include a manufacturer identification code that identifies the manufacturer of the disc and is read by the drive system. The manufacturer identification code is typically engraved into the stamper that is used to injection mold the disks. Consequently, the manufacturer identification is formed in the data layer of optical media during the manufacturing process.

### SUMMARY

In general, the invention is directed to coded optical media that allows a proprietary media handling system to enable privileged access or particular drive features on an optical drive system. In particular, a coded optical medium comprises an otherwise standardized format optical medium that includes machine readable indicia that can be read by the proprietary media handling system. The proprietary media handling system allows access to data stored on medium or, alternatively, enables special features if the indicia identifies the medium as being compliant with drive system. In this manner, the coded optical media and media handling system prevent non-certified media use in the optical drive system or, alternatively, enable specialized features only with optical media having accepted coding.

A coded optical medium may comprise an optical medium compatible with industry standard formats such as compact disc-recordable/rewritable (CD-R/RW), digital versatile disk recordable/rewritable (DVD+/-R/RW), high definition-digital versatile disk-recordable/rewritable (HD-DVD-R/RW), and Blue-Ray disc-recordable/rewritable (BD-R/RE) having machine readable indicia that identify the optical medium as meeting a criteria. Ideally, the machine readable indicia may be read regardless of the orientation of the optical medium in the proprietary media handling system. The machine readable indicia may comprise a repeated barcode pattern, a repeated diffraction grating pattern, or other repeated optically detectable features along a circumference on the non-data or printable side of the optical medium. For example, a coded optical medium may have a repeated barcode pattern inkjet or screen printed along the outer circumference or perimeter on a printable surface of the optical medium. The indicia may also be embossed, for example, into the dummy or blank substrate element of the medium construction and may optionally include information associated with the manufacturer identification or other information on the data or recordable side of the medium. In another example, a coded optical medium may have a first and a second repeated barcode pattern. The first barcode pattern may be repeated along the outer circumference and the second barcode pattern may be repeated along an inner circumference. In any case, the machine readable indicia is affixed to the optical medium in a manner that allows a media handling system to read the indicia regardless of the orientation of the medium in the media handling system.

The machine readable indicia may identify the optical medium as meeting a criteria, such as a particular standard or having particular features. For example, optical media used for archive optical applications are required to meet a standard quality or reliability. The machine readable indicia may also provide added levels of security by requiring password verification prior to allowing access to the optical medium. As an example, the optical medium may enable additional combinations of encoding or multi-level coding, e.g., a manufacturers identification (MID) code, a code associated with a first machine readable indicia, and a user code associated with a second machine readable indicia may be used in various combinations. In any case, a proprietary media handling system may allow privileged access only to optical media meeting particular standards or having acceptable coding.

The proprietary media handling system may comprise recording drives, printing engines, autoloaders, jukeboxes, or other handling systems that load and unload optical media from the optical drive or printing tray. More specifically, the media handling system includes optical sensors or detection elements to read the indicia on the coded optical media. The optical sensors may be affixed in-line of the media traversal at the appropriate media radius to read the indicia as the medium is loaded into the drive system. By repeating the machine readable indicia along a circumference of the medium, the optical sensor may read the indicia as the medium is loaded into the optical drive regardless of the orientation of the medium in the media handling system. Consequently, the media handling system prevents the optical drive from processing non-certified media, may allow special features, such as archive verification software features, only with certified media.

In one embodiment, the invention is directed to an optical medium comprising optically detectable features that store data and are readable by a drive system and machine readable indicia that identify the optical medium as meeting a criteria and are readable by a media handling system, wherein the machine readable indicia are readable regardless of the orientation of the optical medium in the media handling system.

In another embodiment, the invention is directed to a media handling system comprising one or more elements to receive an optical medium that includes optically detectable features that store data and are readable by a drive system, one or more optical elements to read machine readable indicia that identify the optical medium as meeting a criteria, and one or more elements to allow access to the data stored on the optical medium subject to identifying the optical medium as meeting the criteria.

In another embodiment, the invention is directed to a system comprising an optical medium that includes optically detectable features that store data and machine readable indicia to identify the optical medium as meeting a criteria, a media handling system to receive the optical medium, read the indicia, and selectively enable access to data stored on the optical medium subject to identifying the optical medium as meeting the criteria, and a drive system to receive the optical medium and access the data stored on the optical medium upon identifying the optical medium as meeting the criteria.

In another embodiment, the invention is directed to a method comprising receiving an optical medium including optically detectable features that store data and are readable by a drive system and machine readable indicia that identify the optical medium as meeting a criteria and are readable by a media handling system, allowing access to the stored data subject to identifying the optical medium as meeting a criteria, and prohibiting access to the stored data subject to failing to identify the optical medium as meeting the criteria.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an exemplary embodiment of an optical drive system that allows privileged access to optical media subject to identifying the media as meeting a criteria.

FIGS. 2A and 2B are conceptual diagrams illustrating an exemplary embodiment of the non-data side and data side of an optical medium, respectively, suitable for use in the optical drive system.

FIGS. 3A and 3B are conceptual diagrams illustrating an alternative embodiment of the non-data side and data side of an optical medium, respectively, suitable for use in the optical drive system.

FIG. 4 is a block diagram illustrating a media handling system suitable for use in the optical drive system that allows privileged access to optical media subject to identifying the media as meeting a criteria.

FIG. 5 is a conceptual diagram illustrating an optical sensor to reliably read machine readable indicia on an optical medium.

FIG. 6 is a flow chart illustrating a method for allowing privileged access to optical media in accordance with an embodiment of the invention.

### DETAILED DESCRIPTION

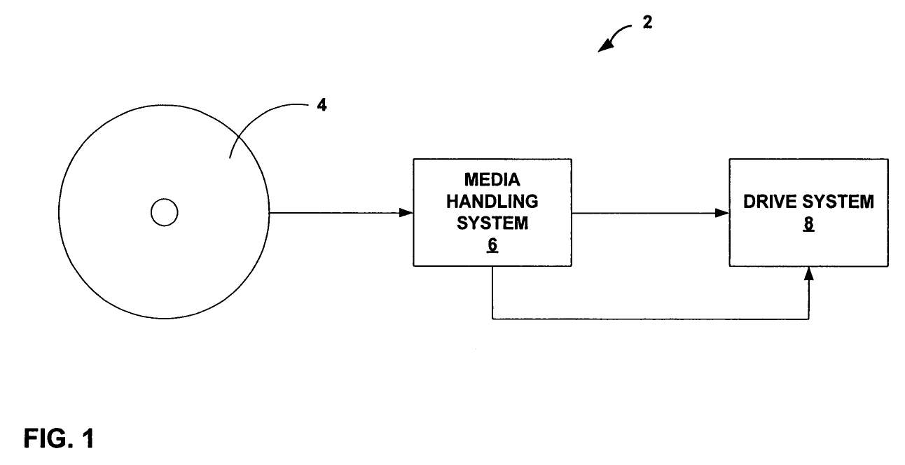

FIG. 1 is a block diagram illustrating an exemplary optical drive system 2 that allows privileged access to optical media 4. In general, optical drive system 2 includes media handling system 6 to load and unload, i.e., shuffle, optical media 4 in and out of optical drive 8 and allow privileged access to optical media 4 subject to identifying optical media as meeting a criteria, and optical drive 8 to physically access optical media 4. For example, if media handling system 6 does not identify optical media 4 as meeting the criteria, optical drive 8 may not access optical media 4 or, alternatively, access only a limited subset of features. In contrast, if media handling system 6 identifies optical media 4 as meeting the criteria, optical drive 8 may access optical media 4 including specialized features, such as proprietary software features. In this manner, optical drive system 2 may prevent non-certified media from being accessed by optical drive 8 and non-authorized from accessing sensitive data stored on optical media 4.

As described herein, optical media 4 may comprise optical media compatible with industry standard formats such as compact disc-recordable/rewritable (CD-R/RW), digital versatile disk recordable/rewritable (DVD+/-R/RW), high definition-digital versatile disk-recordable/rewritable (HD-DVD-R/RW), and Blue-Ray disc-recordable/rewritable (BD-R/RE) having machine readable indicia that identify the optical medium as meeting a criteria. Ideally, the machine readable indicia are readable by media handling system 6 regardless of the rotational orientation of optical media 4 in media handling system 6 and identify optical media 4 as meeting a criteria.

The machine readable indicia may comprise a repeated barcode pattern, a repeated diffraction grating pattern, or other repeated optically detectable features along a circumference on the non-data or printable side of the optical medium. The barcode patterns may be inkjet or screen printed on the non-data or printable side of optical media 4. In some embodiments, optical media 4 may include more than one machine readable indicia to provide multi-level coding. For example, optical media 4 may include a manufacturers identification (MID) code, a first barcode pattern repeated along the outer perimeter or circumference of the disc, and a second barcode pattern repeated along an inner circumference of the disc. The MID code may be molded or formed into the data layer of optical media 4 during fabrication and is read by optical drive 8 to identify the manufacturer. In contrast, the first and second barcode patterns repeated along different circumferences on the non-data side of optical media 4 are read by media handling system 6. In some embodiments, the first barcode pattern may be printed on the non-data side of optical media 4 by the manufacturer or a test facility to identify optical media 4 as meeting particular quality or reliability criteria while the second barcode pattern may be printed by a user to prevent unauthorized access to data stored on optical media 4. Consequently, the machine readable indicia, particularly in conjunction with the MID code, may provide multi-level coding and added levels of security.

In any case, the machine readable indicia may identify optical media 4 as meeting a criteria. The criteria may be a standard quality or reliability required for particular applications, such as archive optical applications or other applications which require long term storage. If media handling system 6 does not identify optical media 4 as meeting the quality or reliability criteria, media handling system 6 prohibits optical drive 8 from accessing optical media 4. However, if media handling system identifies optical media 4 as meeting the quality or reliability criteria, optical drive 8 may access optical media 4 or access special features which are not available if optical media does not meet the criteria. The special features may include, for example, archive verification software in the case archive optical applications.

Alternatively, the criteria may be security related. For example, optical media 4 may store sensitive data. In this case, the machine readable indicia may include a code key or information associated with the MID code that is required to access optical media 4. As an example, prior to optical drive 8 accessing optical media 4, media handling system 6 may require password verification and may prompt a user to enter a password. In this manner, optical media 4 and media handling system 6 may prevent non-certified media and unauthorized users from accessing sensitive data stored on optical media 4.

Media handling system 6 may comprise a proprietary media handling system such as recording drives, printing engines, autoloaders, jukeboxes, or other handling systems that shuffle media in and out of optical drive 8. More specifically, media handling system 6 includes one or more elements (not shown) to shuffle optical media 4 in and out of optical drive 8, optical sensors or detection elements (not shown) to read the indicia on optical media 4, and a processor that allows access to optical media 4. The optical sensors may be affixed in-line of the media traversal at the appropriate media radius to read the indicia as optical media 4 are loaded into the optical drive 8. By repeating the machine readable indicia along a circumference of optical media 4, media handling system 6 may read the indicia as optical media 4 are loaded into optical drive 8, regardless of the orientation of optical media in media handling system 6.

Optical drive 8 may comprise a single drive station or a plurality of drive stations. Optical drive 8 receives optical media 4 from media handling system 6 via a slot, aperture, or transport mechanism, such as an automated tray or arm. Upon receiving optical media 4, optical drive 8 positions the received optical media 4 onto a spindle of the drive station. The drive station may include a drive head with a lens to focus light onto a surface of the data side of optical media 4 in order to read data from or write data back to optical media 4.

In some embodiments, optical drive system 2 forms an automated optical media library system associated with a computing device (not shown). In this case, media handling system 6 allows privileged access to optical media 4 subject to identifying optical media 4 as meeting a criteria and shuffles optical media in and out of optical drive 8 accordingly.

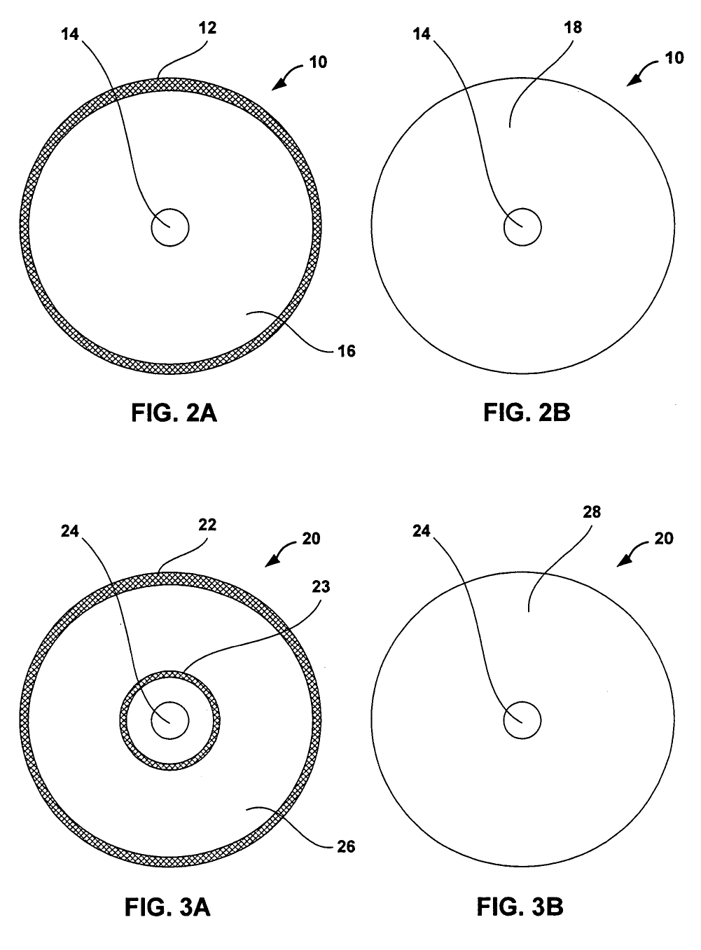

FIGS. 2A and 2B are conceptual diagrams illustrating the non-data side 16 and data side 18 of an optical medium 10, respectively, in accordance with an embodiment of the invention. Optical medium 10 may comprise an optical medium compatible with industry standard formats such as CD-R/RW, DVD+/-R/RW, HD-DVD-R/RW, BD-R/RE). An opening 14 or hole allows optical medium 10 be placed on a spindle in a drive system for reading from or writing to medium 10. In particular, optical medium 10 includes machine readable indicia 12 that identifies medium 10 as meeting a criteria and may be read by media handling system 6 of FIG. 1 regardless of the orientation of optical medium 10 in media handling system 6. In the illustrated embodiment, machine readable indicia 12 are repeated along the circumference of a printable surface of the non-data side 16 of medium 10.

In some embodiments, machine readable indicia 12 may comprise a repeated barcode pattern, a repeated diffraction grating pattern, or other repeated optically detectable features along a circumference on the non-data or printable side 16 of optical medium 10. Barcode patterns or other printable optically detectable patterns may be inkjet or screen printed on the non-data or printable side 16 of optical medium 10 or by surface replication on dummy substrate of two bonded substrates that are bonded to form medium 10. In addition, to make duplication of medium 10 more difficult, machine-readable indicia 12 may be embossed into, for example, an inner surface of 2 sub-bonded construction. Medium 10 may also have a MID code mastered into the data layer 18 and machine readable indicia 12 may optionally include information associated with the MID code.

However, optical medium 10 is not limited as such. For example, in alternative embodiments, machine-readable indicia 12 may comprise a single optically detectable feature anywhere on the non-data 16 or data side 18 of medium 10. In other embodiments, optical medium 10, a transport mechanism of media handling system 6, or both may be fabricated such that medium 10 may only be received by media handling system 6 in a specific orientation. In this case, machine-readable indicia 12 may comprise a single optically-detectable pattern and optical sensors within media handling system 6 may be aligned in a particular manner such that when media handling system 6 receives medium 10, machine readable indicia 12 of medium 10 can be read with high reliability by the optical sensors.

As previously described, machine readable indicia 12 may be applied by the manufacturer to identify medium 10 as meeting a standard quality or reliability criteria. This feature is particularly advantageous in archive optical applications that require long-term storage of records. It may also be advantageous for certain businesses such as legal, finance, medical, and governmental businesses to apply machine readable indicia 12 to prevent unauthorized access to data stored on medium 10. Machine-readable indicia 12 may also be beneficial for businesses with high volumes of records to apply machine readable indicia for tracking purposes.

FIGS. 3A and 3B are conceptual diagrams illustrating the non-data side 26 and data side 28 of an optical medium 20, respectively, having two separate machine readable indicia 22, 23. Again, optical medium 20 may comprise an optical medium compatible with industry standard formats such as CD-R/RW, DVD+/-R/RW, HD-DVD-R/RW, BD-R/RE. Opening 24 allows optical medium 20 be placed on a spindle in a drive system for reading from or writing to medium 20.

In the illustrated embodiment, optical medium 20 includes machine readable indicia 22 along the outer circumference of medium 20 and machine readable indicia 23 along an inner circumference of medium 20. Both machine-readable indicia 22 and 23 are readable by a specialized media handling system, such as media handling system 6, regardless of the orientation of optical medium 20 in the handling system. Machine readable indicia 22 and 23 may comprise a repeated barcode pattern, a repeated diffraction pattern, other repeated optically detectable features along a circumference on the non-data 26 or data side 28 of medium 20, or any combination thereof. Machine readable indicia 22 and 23 may be applied to optical medium 20 as previously described with regard to optical medium 10. Similarly, the data side 28 of optical medium 20 may also include a MID code (not shown).

Machine readable indicia 22, 23, in conjunction with the MID code (not shown), may provide multi-level coding for optical medium 10. For example, the manufacturer may replicate the MID code into a data layer 28 during fabrication of optical medium 20 and apply machine readable indicia 22 to a printable surface of the non-data side 26 of optical medium 20 using screen printing methods. A user may then apply machine readable indicia 23 along an inner circumference, as shown, using inkjet printing methods. The manufacturer may also apply machine-readable indicia 23 as a service to the user. The MID code and machine-readable indicia 22, 23 enable additional security through multi-level coding.

For example, an optical drive may read the MID code to identify the manufacturer. However, in contrast, a specialized media handling system, such as media handling system 6, may read machine readable indicia 22, 23. Machine readable indicia 22 may identify optical medium 20 as meeting particular a quality or reliability criteria and may also be associated with information included in the MID code. In addition, machine-readable indicia 23 may identify optical medium 20 as meeting a security-related criteria. Thus, optical medium 20 may allow privileged access to authorized users if machine readable indicia 22, 23 identify optical medium 20 as meeting particular criteria. However, if machine readable indicia 22, 23 do not identify optical medium 20 as meeting the criteria, the user may be allowed only limited access to a subset of features even to the point of denying access altogether.

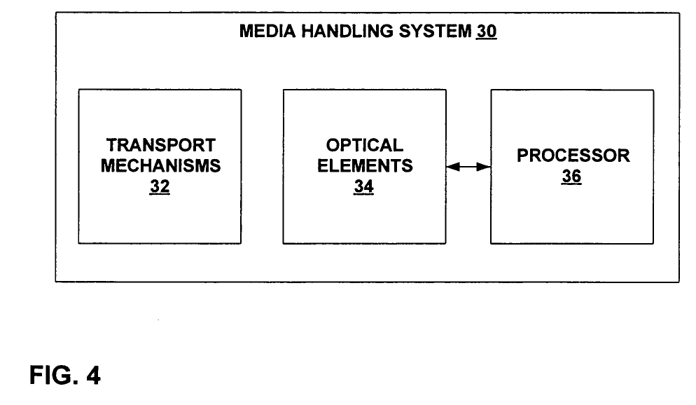

FIG. 4 is a block diagram illustrating media handling system 30 that allows privileged access to optical, such as optical media 10 and 20, subject to identifying the media as meeting a criteria. Media handling system 30 may comprise a proprietary media handling system such as recording drives, printing engines, autoloaders, jukeboxes, or other handling systems that shuffle media in and out of an optical drive (or a printing tray). In some embodiments, media handling system 30 may form part of an automated optical media library system associated with a computing device (not shown). In this case, media handling system 30 shuffles optical media in and out of an optical drive and allows privileged access to the optical media subject to identifying the optical media as meeting particular criteria.

In the illustrated embodiment, media handling system 30 include a transport mechanism 32 to shuffle optical media in and out of an optical drive, optical elements 34 to read machine readable indicia on the optical media, and a processor 36 to allow access to data stored on optical media subject to identifying the optical media as meeting a particular criteria. Transport mechanism 32 may include one or more elements which receive optical media that include machine readable indicia as previously described. More specifically, transport mechanism may transport optical media between a storage case or location that may be internal or external to media handling system 32 and an optical drive. As an example, the storage case may comprise a multi-disc cartridge useful for autoloader or jukebox applications. As a procedural example, in order to load optical media into an optical drive, transport mechanism 32 may retrieve an optical medium from a stack of optical media on a spindle and position the medium on a drive tray. Transport mechanism 32 may unload an optical medium from the optical drive by removing the medium from the tray and position the medium on the appropriate spindle.

Optical elements 34 may read machine-readable indicia on the optical medium when the medium is positioned on the drive tray. Since the drive tray may be in a known, fixed position, optical elements may reliably read machine-readable indicia on optical media described herein. In particular, optical elements 34 may be affixed to a particular position and include a lens to focus a light onto a surface of the optical medium. Since the machine readable indicia is repeated along a circumference of the disc, optical elements 34 can reliably read the machine readable indicia regardless of the orientation of the medium in the tray. Thus, optical elements 34 may be simplified such that they read indicia along one direction, and since the indicia is repeated around the circumference of the disk, optical elements 34 can read at least one occurrence of the indicia regardless of orientation.

In another example, transport mechanism 32 may be programmed to pass media through a fixed path or point, such as along a linear path. Thus, optical elements 34 can be affixed in-line of the media traversal at the appropriate radius to reliably read the machine-readable indicia since the media will pass under optical elements 34 in a specified linear path.

Optical elements 34 output a signal to processor 36 based on the information received from the machine-readable indicia on the optical media. Processor 36 processes the signal received from optical elements 34 and allows privileged access to data stored on the media or enables special features, such as archive verification software in archive optical applications, if the output signal identifies the media as meeting particular criteria. If processor 36 process the output signal and does not identify the media as meeting particular criteria, the processor 36 may allow access to only a limited subset of features even to the point of prohibiting access to the media altogether. In particular, processor 36 may be communicatively coupled to an optical drive and output a corresponding signal to prohibit or allow access to the media.

Processor 36 may comprise a microprocessor, a digital signal processor (DSP), application specific integrated circuits (ASICs), field-programmable gate arrays (FPGAs), or other equivalent logic circuitry. Processor 36 may also comprise a general-purpose processor that executes software instructions to perform the techniques described herein.

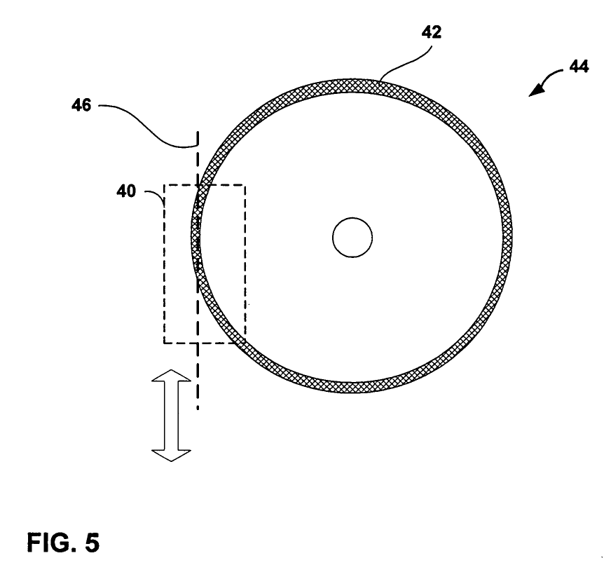

FIG. 5 is a conceptual diagram illustrating an optical sensor 40 to reliably read machine readable indicia 42 on an optical medium 44 with linear motion of optical medium 44 along a linear scanning axis 46. Machine-readable indicia 42 may comprise an optically detectable pattern repeated along the outer circumference of optical medium 44. Consequently, optical sensor may reliably read machine-readable indicia 42 regardless of the orientation of medium 44 during traversal along linear scanning axis 46.

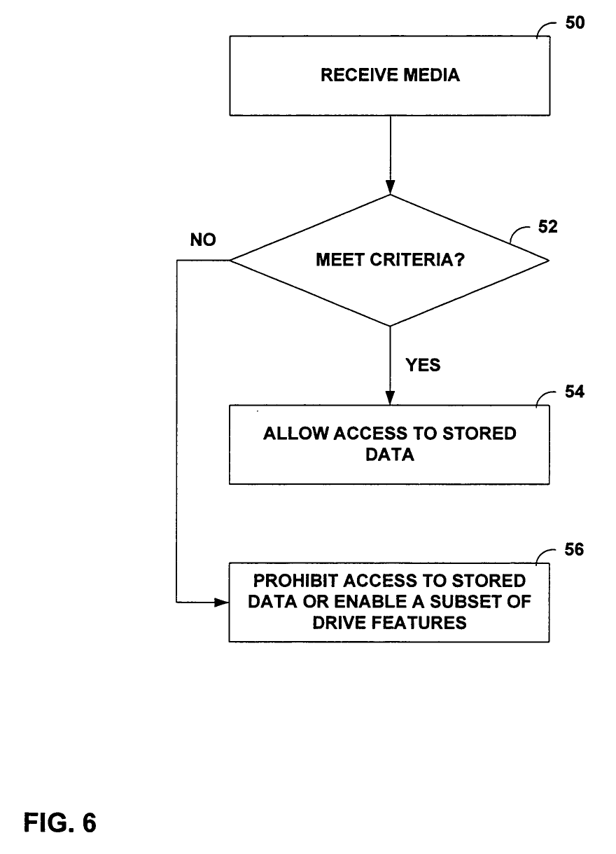

FIG. 6 is a flow chart illustrating a method for allowing privileged access to optical media 4 in accordance with an embodiment of the invention. Initially, media-handling system 6 receives optical media 4 (50). Next, media-handling system 6 reads machine-readable indicia on optical media 4 to identify if optical media 4 meets particular criteria (52). In general, optical media 4 includes machine readable indicia readable by media handling system 6 regardless of the orientation of optical media in media handling system 6. The machine-readable indicia may comprise a repeated barcode pattern, a repeated diffraction grating pattern, or other repeated optically detectable feature along a circumference of optical media 4. The machine readable indicia may be embossed on an inner surface, inkjet or screen printed on a printable surface of the non-data side of optical media 4, or surface replicated on a dummy substrate of optical media 4.

In any case, the machine-readable indicia identify optical media 4 as meeting particular criteria such as quality, reliability, or security related criteria. For example, a manufacturer may apply machine-readable indicia to optical media 4 to identify media 4 as meeting particular quality or reliability standards for archive optical applications. In another example, a user may apply machine-readable indicia to optical media 4 to identify optical media 4 as storing sensitive information. Accordingly, the machine-readable indicia may be associated with a code key or information stored in the MID code. In yet another example, optical media may include a plurality of machine-readable indicia to provide multi-level coding and additional levels of security.

If media-handling system 6 identifies optical media as meeting the criteria, media handling system 6 allows access to data stored on optical media 4 (54). In particular, media handling system may enable special features, such as archive verification software in this case. However, when media handling system 6 does not identify optical media 4 as meeting the criteria, media handling system 6 prohibits access to stored data altogether or, alternatively, enables a limited subset of drive features (56). In other words, media handling system 6 may enable a limited subset of system features, even to the point of prohibiting access to stored data altogether.

Various embodiments of the invention have been described. These and other embodiments are within the scope of the following claims.

1. An optical medium comprising:
optically detectable features that store data and are readable by a drive system;
machine-readable indicia that identify the optical medium as meeting a criteria and are readable by a media handling system.

2. The optical medium of claim 1, wherein the machine readable indicia are readable regardless of the orientation of the optical medium in the media handling system.

3. The optical medium of claim 1, wherein the machine readable indicia includes one or more of a repetitive multiplicity of diffraction grating patterns on a non-data side of the optical medium, a repetitive multiplicity of barcode patterns on a non-data side of the optical medium, a repetitive multiplicity of barcode patterns along an outer circumference of a non-data side of the optical medium, and a repetitive multiplicity of barcode patterns along an inner diameter of a non-data side of the optical medium.

4. The optical medium of claim 1, wherein the machine-readable indicia are inkjet or screen-printed on a printable surface of a non-data side of the optical medium.

5. The optical medium of claim 1, wherein the machine-readable indicia are encased within bonded interfaces of the optical medium.

6. The optical medium of claim 1, wherein the machine-readable indicia identify the optical medium as meeting a manufacturer associated criteria and allow access to the stored data subject to the media handling system identifying the optical medium as meeting the manufacturer associated criteria.

7. The optical medium of claim 1, wherein the machine readable indicia identify the optical medium as meeting a user associated criteria and enable one or more drive features subject to the media handling system identifying the optical medium as meeting the user associated criteria and receiving a code key associated with the machine readable indicia from a user.

8. The optical medium of claim 1, further comprising a drive-readable manufacturer identification (MID) code and wherein the machine readable indicia include information associated with the MID code.

9. The optical medium of claim 1, further comprising:
a manufacturer identification (MID) on the data side of the optical medium readable by the drive system, and
wherein the machine readable indicia include a first repetitive multiplicity of barcode patterns on the non-data side of the optical medium identifying the optical medium as meeting a manufacturer associated criteria and a second repetitive multiplicity of barcode patterns on a non-data side of the optical medium identifying the optical medium as meeting a user associated criteria.

10. The optical medium of claim 1, wherein the optical medium comprises one of a compact disk read only memory (CD-ROM), a recordable compact disc (CD-R), a rewritable compact disk (CD-RW), a digital video disc read only memory (DVD-ROM), a DVD-R, a DVD-RW, a DVD+R, a DVD+RW, a HD-DVD-R, a HD-DVD-RW, a Blu-ray disc read only memory (BD-ROM), a BD-R, a BD-RE, and other such interchangeable standard format compact disc media.

11. The optical medium of claim 1, wherein the optical medium is included within a multi-disc cartridge.

12. A media handling system comprising:
one or more elements to receive an optical medium that includes optically detectable features that store data and are readable by a drive system;
one or more optical elements to read machine readable indicia that identify the optical medium as meeting a criteria; and
one or more elements to allow access to the data stored on the optical medium subject to identifying the optical medium as meeting the criteria.

13. The system of claim 12, wherein the one or more optical elements read the machine readable indicia regardless of the orientation of the optical medium within the media handling system.

14. The system of claim 12, wherein the one or more elements that receive the optical medium receive the optical medium in a linear motion, and the one or more optical elements are affixed in-line of the optical medium traversal at the appropriate media radius to read the machine readable indicia regardless of the orientation of the optical medium within the media handling system.

15. The system of claim 12, wherein the machine readable indicia includes one or more of a repetitive multiplicity of diffraction grating patterns on a non-data side of the optical medium, a repetitive multiplicity of barcode patterns on a non-data side of the optical medium, a repetitive multiplicity of barcode patterns along an outer circumference of a non-data side of the optical medium, and another repetitive multiplicity of barcode patterns along an inner diameter of the non-data side of the optical medium.

16. The system of claim 12, wherein the optical elements comprise one or more of a barcode scanner and a diffraction pattern sensor.

17. The system of claim 12, wherein the one or more elements that allow access to the data stored on the optical medium enable one or more drive features subject to identifying the optical medium as meeting the criteria and enable only a subset of drive features subject to failing to identify the optical medium as meeting the criteria.

18. The system of claim 12, wherein the one or more optical elements read the machine readable indicia and the manufacturer identification (MID) to identify the optical medium as meeting the criteria.

19. A system comprising:
an optical medium that includes optically detectable features that store data and machine readable indicia to identify the optical medium as meeting a criteria;
a media handling system to receive the optical medium, read the indicia, and selectively enable access to data stored on the optical medium subject to identifying the optical medium as meeting the criteria; and
a drive system to receive the optical medium and access the data stored on the optical medium upon identifying the optical medium as meeting the criteria.

20. A method comprising:
receiving an optical medium including optically detectable features that store data and are readable by a drive system and machine readable indicia that identify the optical medium as meeting a criteria and are readable by a media handling system;
allowing access to the stored data subject to identifying the optical medium as meeting the criteria; and
limiting access to the stored data subject to failing to identify the optical medium as meeting the criteria.

21. A method comprising:
receiving a medium including two or more features that identify the medium as meeting a criteria;
allowing access to data stored on the medium upon identifying the medium as meeting the criteria based on the two or more features; and
limiting access to the stored data upon failing to identify the medium as meeting the criteria.

22. The method of claim 21, wherein the two or more features comprise an optically detectable bar code and a machine readable manufacturer identification (MID) code.
